(19) United States
(12) Patent Application Publication
(10) Pub. No.: US 2013/0103801 A1
(43) Pub. Date: Apr. 25, 2013

(54) WIND PARK NETWORK SYSTEM

(71) Applicants: Ulrich Vestergaard B. Hansen, Herning (DK); Jannik Hoejgaard, Brande (DK); Michael Jensen, Viborg (DK); Vivek Kulkarni, Unterhaching (DE)

(72) Inventors: Ulrich Vestergaard B. Hansen, Herning (DK); Jannik Hoejgaard, Brande (DK); Michael Jensen, Viborg (DK); Vivek Kulkarni, Unterhaching (DE)

(21) Appl. No.: 13/805,682

(22) PCT Filed: Sep. 24, 2010
(86) PCT No.: PCT/EP2010/064139

§ 371 Date: Dec. 20, 2012

(30) Foreign Application Priority Data
Jun. 22, 2010 (EP) 10166867.1

(51) Int. Cl. H04L 29/06

(52) U.S. Cl. CPC H04L 65/1013
USPC 709/217

(57) ABSTRACT

A wind park network system is provided. The network system has a first and a second networks, a first and a second wind turbines representing a first and a second network elements, a first central unit and a second central unit for transmitting messages within the first and the second networks respectively. The first and the second wind turbines are connected to the first and the second central units within the first and the second networks respectively. The first and the second central units are connected. The first and the second networks are in a star topology and operate independently from each other such that a redundant network topology for the first and the second networks is realized.

### CROSS REFERENCE TO RELATED APPLICATIONS

This application is the US National Stage of International Application No. PCT/EP2010/064139 filed Sep. 24, 2010 and claims the benefit thereof. The International Application claims the benefits of European application No. 10166867.1 filed Jun. 22, 2010, both of the applications are incorporated by reference herein in their entirety.

### FIELD OF INVENTION

The present invention relates to the field of wind parks. In particular the invention relates to a wind park network system for providing a redundant network topology. Further, the present invention relates to a method for providing a redundant network topology. Moreover, the present invention relates to a computer program that controls wind parks, which is adapted for performing the above mentioned method.

### BACKGROUND OF THE INVENTION

The wind turbines in wind parks can be connected via networks for facilitating a system that provides a remote control of wind turbines in the wind parks. The network architecture as of today is being handled as per requirements from the individual customers. This includes network planning such as IP (Internet Protocol) addresses and their mappings to devices, Virtual LANs (VLAN=Virtual Local Area Network), and Monitoring. Each network component needs to be specifically configured for each individual wind park. All these tasks are time consuming and very prone to human error.

Further, in today's wind farm network architecture, all the wind turbines are connected in a ring architecture. Within this architecture, VLANs may be used for process and power regulation. The process and power regulation VLANs can either be on same fiber or different fibers for isolation and independence purpose. Due to the ring architecture only a single point of failure, like fiber strands or node failure, is covered. In case of double failure either of fiber links or of double node failure, the partial/whole ring is affected due to loss of communication.

Therefore there may be a need for providing a more failure-safe and more reliable network system for wind parks.

### SUMMARY OF THE INVENTION

This need may be met by the subject matter according to the independent claims. Advantageous embodiments of the present invention are described by the dependent claims.

According to a first aspect of the invention, there is provided a wind park network system comprising a first network and a second network, a first wind turbine and a second wind turbine representing a first network element and a second network element, a first central unit adapted to act as a conduit for transmitting messages within the first network, and a second central unit adapted to act as a conduit for transmitting messages within the second network. Therein the first wind turbine and the second wind turbine are connected to the first central unit within the first network and to the second central unit within the second network, wherein the first central unit and the second central unit are connected. The first network and the second network are configured in a star topology, and the first network is adapted to operate independently from the second network and the second network is adapted to operate independently from the first network, such that a redundant network topology for the first network and the second network is realized.

In conventional wind farms, there exist several approaches to provide either redundancy in networks or to provide a separation between connections for different purposes. Typically, a ring topology is used for wind park networks. For example, parallel fiber rings may be used to separate for example process and power regulation traffic. The issue of redundancy in case of double failure is not realized in this case.

This aspect of the invention is based on the idea to provide a better redundancy by using a redundant star topology for each wind turbine. In case of double failure (fiber strands/network node), one can be sure that the impact lies with only one turbine as a worst case scenario.

For this purpose, a network topology may be used called star topology. In its simplest form, the first star network comprises a first central unit, which may be a central switch, or computer, which acts as a conduit to transmit messages. The first central unit may be connected to a first wind turbine representing a first network element (leaf node) and to a second wind turbine representing a second network element (leaf node). Thus, the central unit (central node), the first and the second network element (leaf nodes), and the transmission lines between them form a graph with the topology of a star.

According to this aspect of the invention, the wind park network system comprises a second central unit, which is also connected to the first network element and the second network element and may provide therefore a second star network. The second network may have the same features as described together with the first network above.

The star topology may reduce the chance of network failure by connecting all of the systems to a central node. All peripheral nodes may thus communicate with all others by transmitting to, and receiving from, the central node only. The failure of a transmission line linking any peripheral node to the central node will result in the isolation of that peripheral node from all others, but the rest of the systems will be unaffected.

The wind park network system may provide a better performance than common wind farm networks. By the star topology, the passing of data packets through an excessive number of nodes may be prevented. For example, at most, 3 devices and 2 links may be involved in any communication between any two devices. Further, each device (leaf node) may be inherently isolated by the link that connects it to the central unit. This may make the isolation of individual devices straightforward. This isolation may also prevent any non-centralized failure, for example of a wind turbine, from affecting the network.

By connecting each network element to at least two central units, double failures may be covered so that the networks are adapted to work independently from each other. Thus, communications may be conducted over the second network if any problems occur in the first network and vice versa.

According to a further embodiment of the invention, the first network is a first virtual local area network and the second network is a second virtual local area network.

A virtual local area network, commonly known as a VLAN, may be a group of hosts (in this case the first central unit and the second central unit connected to the first wind turbine and the second wind turbine) with a common set of requirements that communicate as if they were attached to the same broadcast domain, regardless of their physical location. A VLAN may have the same attributes as a physical LAN, but it may allow for end stations to be grouped together even if they are not located on the same network switch. Network reconfiguration can be done for example through software instead of physically relocating devices.

To physically replicate the functions of a VLAN, it would be necessary to install a separate, parallel collection of network cables and switches/hubs which are kept separate from the primary network. Thus, two separate networks, the first and the second network, may be provided by using the same network cables. By this embodiment, it may be possible to save for example up to 50% of the cost for the network infrastructure, by saving on fiber cabling and installation, switch assets, device management in lifetime period, as only one network infrastructure is utilized whilst having all the benefits from a parallel infrastructure.

According to a further embodiment of the invention, the first network and the second network are configured to use a spanning tree protocol.

The spanning tree protocol (STP) is a link layer network protocol that ensures a loop-free topology for any bridged LAN. Thus, the basic function of STP is to prevent bridge loops and ensuing broadcast storms. The STP may create a spanning tree within a mesh network, in this case the first and the second network, of connected bridges, i.e. the first and the second central unit, and may disable those links that are not part of the spanning tree, leaving a single active path between any two network nodes.

Spanning tree allows a network design to include spare (redundant) links to provide automatic backup paths if an active link fails, without the danger of bridge loops, or the need for manual enabling/disabling of these backup links.

According to a further embodiment of the invention, the first network and the second network are configured to use a rapid spanning tree protocol, wherein the first central unit is adapted to operate as root element.

The Rapid Spanning Tree Protocol (RSTP) may provide for faster spanning tree convergence after a topology change, for example due to failure of nodes or connections. RSTP is a refinement of STP and therefore shares most of its basic operation characteristics. In contrast to SPT, RSTP will respond to packets sent from the direction of the root element or bridge. An RSTP bridge will “propose” its spanning tree information to its designated ports, which are forwarding ports for every LAN segment. If another RSTP bridge receives this information and determines this is the superior root information, it sets all its other ports to discarding. The bridge may send an “agreement” to the first bridge confirming its superior spanning tree information. The first bridge, upon receiving this agreement, knows it can rapidly transition that port to the forwarding state bypassing the traditional listening/learning state transition. This essentially creates a cascading effect away from the root bridge where each designated bridge proposes to its neighbors to determine if it can make a rapid transition. Further, RSTP maintains backup details regarding the discarding status of ports. This may avoid timeouts if the current forwarding ports were to fail or packets were not received on the root port in a certain interval.

According to a further embodiment of the invention, the first network and the second network are configured to use a multiple spanning tree protocol, wherein the first central unit is adapted to operate as root element for the first network and wherein the second central unit is adapted to operate as root element for the second network.

The Multiple Spanning Tree Protocol (MSTP) defines an extension to RSTP to further develop the usefulness of virtual LANs (VLANs). This “Per-VLAN” Multiple Spanning Tree Protocol configures a separate spanning tree for each VLAN group, i.e. for the first network and for the second network, and blocks all but one of the possible alternate paths within each spanning tree. In case of failure within one VLAN, i.e. within the first or the second network, also the other network may be used for alternative paths.

According to a further embodiment of the invention, the first network is adapted to transmit information with a higher priority than the second network.

Over the first network, information and data may be transmitted with a higher priority.

That means that this information is transmitted before the information within the second network is transmitted.

According to a further embodiment of the invention, the first network is adapted to transmit transmission critical information, in particular time critical information, and wherein the second network is adapted to transmit non-transmission critical information.

By this embodiment, it may be ensured that transmission critical information, which is transmitted over the first network, may be handled in a different way like information, which is not transmission critical and which is transmitted over the second network. For example, transmission critical information may be higher prioritized than non-transmission critical information.

According to a further embodiment of the invention, the first central unit is adapted to act as a conduit for transmitting messages within the second network in case of failures within the second network and/or wherein the second central unit is adapted to act as a conduit for transmitting messages within the first network in case of failures within the first network.

The first network may represent a backup network for the second network and vice versa. By this embodiment, failure safety may be provided by the backup handling and redundancy of the system.

According to a further embodiment of the invention, the first wind turbine represents a plurality of network elements and/or wherein the second wind turbine represents a plurality of network elements.

Each wind turbine may comprise more than one network element for different parts of the wind turbine. These parts may be for example the engine, the control system, brakes, blade control etc. By this embodiment, it may be possible to control each part of the wind turbine as an individual single network element and to send control information directly to the designated part. Further, the network elements may also send individually information to a central controller or the like.

According to a further embodiment of the invention, the plurality of network elements of the first wind turbine comprises the same local network configuration as the plurality of network elements of the second wind turbine.

In common system, the network components of the wind farm are not a factory product. Factory product here means that the network component is always having the same and final network configuration parameters when they leave the factory. Here factory products can be turbine equipments or SCADA (Supervisory Control And Data Acquisition) control equipments.

This embodiment may provide the advantage that every single turbine or every SCADA component does not need to be individually configured during the first installation as well as during the lifetime replacements for a specific wind park project.

According to a further embodiment of the invention, the wind park network system comprises a backbone system for mapping the local network configuration of the plurality of network elements of the first wind turbine and of the plurality of network elements of the second wind turbine to a global network configuration.

The backbone network or system may provide a path for the exchange of information between different local area networks or sub-networks. The backbone system or switch may comprise a remapping unit for remapping local VLANs to unique VLANs in the backbone switch identifying each turbine. The backbone switch may further comprise a network address translation (NAT) unit for converting overlapping private addresses of the wind turbines to global unique IP addresses. Furthermore, the backbone switch may comprise a communication unit for configuring the VLANs to communicate with, for example a power regulation and a process server. The power regulation and process server may also be part of the network and may be connected to the first and/or second central unit.

According to a further embodiment of the invention, the first network and/or the second network may comprise a supervisory control and data acquisition system.

The supervisory control and data acquisition system (SCADA) may refer to an industrial control system: a computer system monitoring and controlling a process, for example industrial processes like power generation, infrastructure processes like electrical power transmission and distribution, Wind Farms. The SCADA may be connected via a NAT system for SCADA control servers to the first and the second network.

According to a further aspect of the invention, it is provided a method for providing a redundant network topology within a wind park network system. Therein the wind park network system comprises a first network and a second network, a first wind turbine and a second wind turbine representing a first network element and a second network element, a first central unit adapted to act as a conduit for transmitting messages within the first network, and a second central unit adapted to act as a conduit for transmitting messages within the second network. The method comprises further connecting the first wind turbine and the second wind turbine to the first central unit within the first network and to the second central unit within the second network, wherein the first central unit and the second central unit are connected. The first network and the second network are configured in a star topology. The method comprises further operation of the first network independently from the second network, and operation of the second network independently from the first network, such that a redundant network topology for the first network and the second network is realized.

According to a further aspect of the invention, there is provided a computer program for providing a redundant network topology within a wind park network system, the computer program, when being executed by a data processor, is adapted for controlling the method having the above mentioned features.

As used herein, reference to a computer program is intended to be equivalent to a reference to a program element and/or to a computer readable medium containing instructions for controlling a computer system to coordinate the performance of the above described method.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

### BRIEF DESCRIPTION OF THE DRAWING

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 shows a wind park network system according to an embodiment of the invention.

FIG. 2 shows a wind park network system according to a further embodiment of the invention.

FIG. 3 shows a wind park network system according to a further embodiment of the invention.

FIG. 4 shows a wind park network system comprising a backbone system according to an embodiment of the invention.

### DETAILED DESCRIPTION OF THE INVENTION

The invention is schematically illustrated in the drawings. It is noted that in different figures, similar or identical elements are provided with the same reference signs or with reference signs, which are different from the corresponding reference signs only within the first digit.

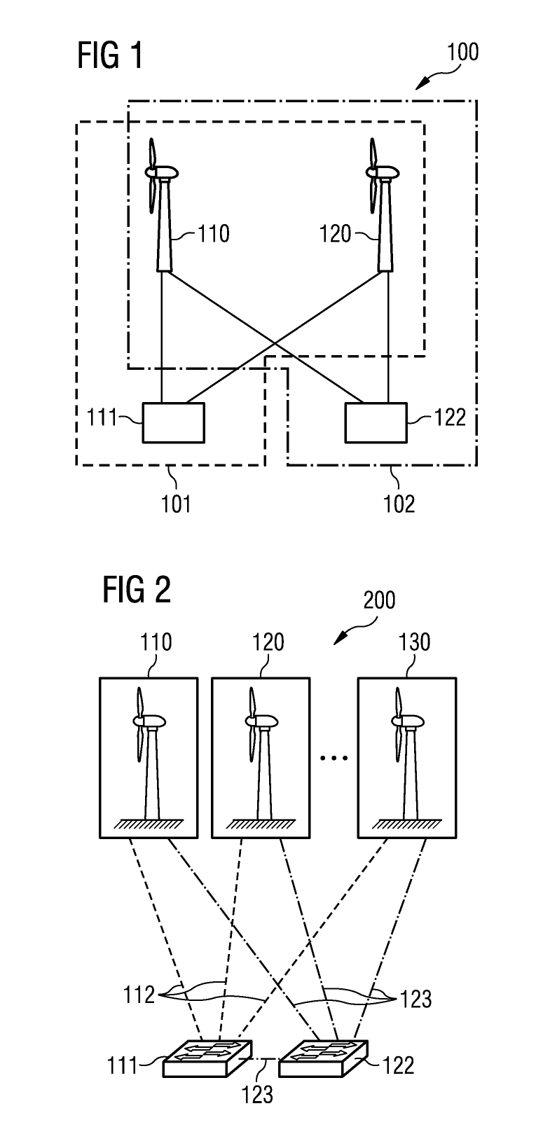

FIG. 1 shows a wind park network system 100 according to an embodiment of the invention. The wind park network system comprises a first network 101 and a second network 102. A first wind turbine 110 representing a first network element is connected with a first central unit 111 within the first network and a second central unit 122 within the second network. A second wind turbine 120 representing a second network element is connected with the first central unit and the second central unit.

The first central unit 111 is adapted to act as a conduit for transmitting messages within the first network. The second central unit 122 is adapted to act as a conduit for transmitting messages within the second network. The first and the second central unit may be connected to each other. Both, the first network and the second network, are configured in a star topology. By the star topology and by the fact that the first network is adapted to operate independently from the second network, a redundant network topology for the first and the second network may be realized.

In common wind farm network architectures, all the wind turbines are connected in a ring architecture. The process and power regulation VLANs can either be on same fiber or different fibers for isolation and independence purpose. Due to the ring architecture only a single point of failure is covered, this be fiber strands or node failure. So in case of double fiber link or double node failure, the partial/whole ring is affected due to loss of communication.

In the embodiment of FIG. 1, the first network and the second network may be VLANs, being responsible for process and power regulation, wherein these tasks may be divided to the first and the second network. In case of double failure, the first and the second network provide sufficient redundancy so that the wind park network may be operated anyway.

FIG. 2 shows a further embodiment of the invention. In the wind park network system 200, the system may comprise up to n wind turbines, wherein three wind turbines are shown: a first wind turbine 110, a second wind turbine 120 and a third wind turbine 130. Each wind turbine represents a network element and is connected to a first central unit 111, operating as root element, and a second central unit 122.

By providing redundant star topology for each wind turbine, the process and power regulation networks can be provided over different fibers. The In case of double failure (fiber strands/network node), one can be sure that the impact lies with only one turbine as a worst case scenario. FIG. 2 provides a star topology making use of single spanning tree domain, where transmission or mission-critical VLANs traverse over one fiber, 112, and non-transmission or non-mission critical VLANs traverse over other fiber, 123. The non-transmission critical messages are then transmitted from central unit 122 to the root element 111. The redundancy in this network is achieved in such a way that if one fiber breaks, then the VLANs over that fiber will traverse over other fiber with their priority. The priority may be set previously according to application importance. The change of the path is possible as the root element 111 and the second central unit 122 are coupled.

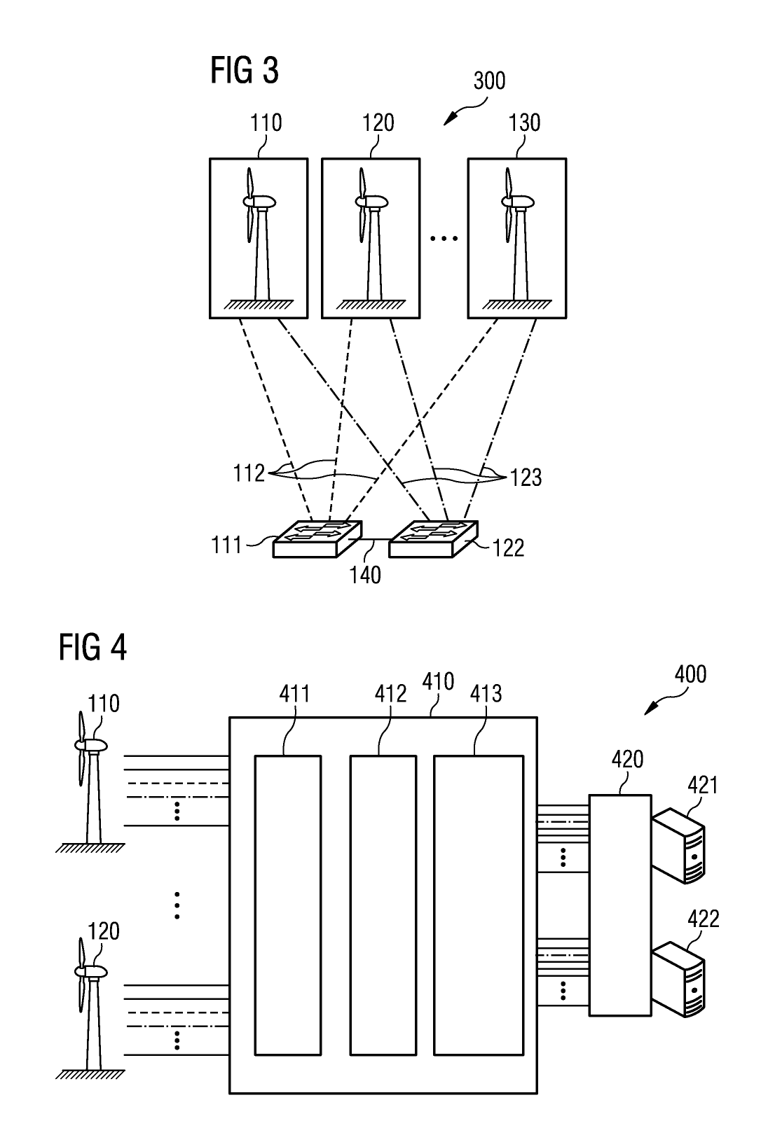

In FIG. 3, the network system 300 corresponds to the network system of FIG. 2, but is operated with a per-VLAN spanning tree (multiple spanning tree) which can be used to separate the traversal of transmission critical and non-transmission critical VLANs. Both central units are operated as root elements, central unit 111 as root element for transmission critical data and central unit 122 as root element for non-transmission critical data. The connection 140 between the central units serves as backup connection for failures. After one fiber failure the VLANs on that fiber, will traverse through other fiber, and as well as over the connection 140.

FIG. 4 shows a wind park network system 400 comprising a backbone system 410 according to an embodiment of the invention. A plurality of wind turbines 110, 120 may be coupled to the backbone system or backbone switch 410. Each network element of the wind turbines may be coupled through a line to the backbone switch. Each wind turbine comprises the same network configuration, like identical VLANs and identical IP addresses for each connected device in the wind turbine. These networking parameter settings can be preconfigured in the factory. This eliminates on-site network configurations of these connected devices. By providing same configurations for each of the networking component of wind farm network, the network may be much simplified for network management and monitoring, and human errors may be eliminated. The whole system may be “plug and play”, requiring little or no network knowledge of the technicians on the site.

The backbone system or switch may comprise a remapping unit 411 for remapping local VLANs to unique VLANs in the backbone switch identifying each turbine. Port based Access Control Lists and or VLAN-Access Control lists could be used to separate identical VLANs from factory product into unique VLANs at the backbone network. The backbone switch may further comprise a network address translation (NAT) unit 412 for converting overlapping private addresses of the wind turbines to global unique IP addresses.

Furthermore, the backbone switch may comprise a communication unit 413 for configuring the VLANs to communicate with, for example a power regulation 421 and a process server 422. Here, remapping of translated IP addresses from individual turbine components to unique VLANs may be necessary for communication. The power regulation and process server may also be part of the network and may be connected to the first and/or second central unit.

A supervisory control and data acquisition system (SCADA) may be coupled with the wind turbines via a central unit. For this purpose, the wind park network system 400 may comprise a NAT system 420 for connecting SCADA control servers to the first and the second network.

Embodiments of the invention provide in a first aspect same configurations for each of the networking component of a wind farm network. In a second aspect, a redundant star topology network is provided for each wind turbine in a wind park.

Thus, it may be possible to save up to 50% of the cost for the network infrastructure (savings on: fiber cabling and installation, switch assets, device management in lifetime period) by utilizing only one network infrastructure but still having all the benefits from a parallel infrastructure. The localization of fault may limit to a particular turbine and might not affect other turbines in the network. Same configurations for all network components inside wind turbines and SCADA control servers may be provided. The know-how requirement may be greatly reduced by standardizing identical turbine configurations. Ease of replacement and maintenance during the lifetime of the turbine may be provided. A redundant star topology for mission-critical and non-mission critical traffic separation may be provided. Turbine components may already know where to find each other and may bring ease in commissioning. VLAN prioritization in star topology may add redundancy and data traffic prioritization during link failure.

According to aspects of the invention, the following concepts may be suggested. In a first concept, a wind park network system comprises two or more networks connected to two or more wind turbines where the networks work independently of each other. In a second concept, the networks work as a redundant star topology network. In a third concept, the networks are further connected to one or more roots. In a fourth concept, the networks connected to each wind turbine comprise at least one mission-critical network and at least one no-mission-critical network. In a fifth concept, the mission-critical network connected to each wind turbine is further connected to a first root and where the no-mission-critical network connected to each wind turbine is further connected to a second root. In a sixth concept, the networks are prioritized at one or more of the roots by network control means and/or a network protocol. In a seventh concept, the wind park network system comprises the same network configuration and/or the same IP address for all wind turbines in the wind park. In a eighth concept, the wind park network system further comprises a switch providing network remapping to unique networks for identifying each wind turbine, and/or the switch providing a NAT (Network Address Translation) translating overlapping identical IP addresses to unique global IP addresses, and/or the switch providing configured networks for communication with one or more power regulation servers and/or process servers. In a ninth concept, the wind park network system further comprises a NAT for SCADA control servers. In a tenth concept, the networks comprise VLANs. In an eleventh concept, a protocol for controlling and handling the network system comprises a RSTP and/or a MSTP protocol.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

### LIST OF REFERENCE SIGNS

100 wind park network system
101 first network
102 second network
110 first wind turbine
111 first central unit
112 connections for mission-critical information
120 second wind turbine
122 second central unit
123 connections for non-mission-critical information
130 third wind turbine
140 connection between first and second root element
410 backbone system
411 remapping unit
412 NAT unit
413 communication unit
420 NAT unit for SCADA
421 power regulation server
422 process server

1.-14. (canceled)

15. A wind park network system, comprising:
a first network and a second network;
a first wind turbine and a second wind turbine representing a first network element and a second network element respectively;
a first central unit adapted to transmit messages within the first network; and
a second central unit adapted to transmit messages within the second network,
wherein the first wind turbine is connected to the first central unit within the first network,
wherein the second wind turbine is connected to the second central unit within the second network,
wherein the first central unit and the second central unit are connected to each other,
wherein the first network and the second network are configured in a star topology, and
wherein the first network and the second network are adapted to operate independently from each other to provide a redundant network topology for the first network and the second network respectively.

16. The wind park network system as claimed in claim 15, wherein the first network is a first virtual local area network and the second network is a second virtual local area network.

17. The wind park network system as claimed in claim 15, wherein the first network and the second network are configured to use a spanning tree protocol.

18. The wind park network system as claimed in claim 17, wherein the first network and the second network are configured to use a rapid spanning tree protocol, and wherein the first central unit is adapted to operate as a root element.

19. The wind park network system as claimed in claim 17, wherein the first network and the second network are configured to use a multiple spanning tree protocol, wherein the first central unit is adapted to operate as a root element for the first network, and wherein the second central unit is adapted to operate as a root element for the second network.

20. The wind park network system as claimed in claim 15, wherein the first network is adapted to transmit information with a higher priority than the second network.

21. The wind park network system as claimed in claim 15, wherein the first network is adapted to transmit mission-critical information, and wherein the second network is adapted to transmit non-mission-critical information.

22. The wind park network system as claimed in claim 21, wherein the mission-critical information comprises time critical information.

23. The wind park network system as claimed in claim 15, wherein the first central unit is adapted to transmit the messages within the second network when a failure occurs within the second network, and/or wherein the second central unit is adapted to transmit the messages within the first network when a failure occurs within the first network.

24. The wind park network system as claimed in claim 15, wherein the first wind turbine represents a plurality of first network elements, and/or wherein the second wind turbine represents a plurality of second network elements.

25. The wind park network system as claimed in claim 24, wherein the plurality of the first network elements comprises a same local network configuration as the plurality of the second network elements.

26. The wind park network system as claimed in claim 25, further comprising a backbone system for mapping the local network configuration to a global network configuration.

27. The wind park network system as claimed in claim 15, wherein the first network and/or the second network comprise a supervisory control and data acquisition system.

28. A method for providing a redundant network topology within a wind park network system, wherein the wind park network system comprises a first network and a second network, a first wind turbine and a second wind turbine representing a first network element and a second network element respectively, a first central unit adapted to transmit messages within the first network, and a second central unit adapted to transmit messages within the second network, the method comprising:
connecting the first wind turbine to the first central unit within the first network;
connecting the second wind turbine to the second central unit within the second network;
connecting the first central unit to the second central unit;
providing a star topology for the first network and the second network respectively; and
operating the first network and the second network independently from each other to provide the redundant network topology for the first network and the second network respectively.

29. A computer program executed by a data processor for providing a redundant network topology within a wind park network system, wherein the wind park network system comprises a first network and a second network, a first wind turbine and a second wind turbine representing a first network element and a second network element respectively, a first central unit adapted to transmit messages within the first network, and a second central unit adapted to transmit messages within the second network, the computer program comprising:
a program code for performing method steps as claimed in claim 28.
